(19) United States
(12) Patent Application Publication
(10) Pub. No.: US 2014/0028141 A1
(43) Pub. Date: Jan. 30, 2014

(54) ROTOR AND GENERATOR FOR REDUCING HARMONICS

(71) Applicant: Illinois Tool Works Inc., Glenview, IL (US)

(72) Inventor: Randall J. DuVal, Appleton, WI (US)

(21) Appl. No.: 13/910,056

(22) Filed: Jun. 4, 2013

Related U.S. Application Data
(60) Provisional application No. 61/676,709, filed on Jul. 27, 2012.

(51) Int. Cl. H02K 3/16; H02K 15/09

(52) U.S. Cl. CPC H02K 3/16; H02K 15/09
USPC 310/183; 29/596

(57) ABSTRACT

A rotor for a generator comprises a stack of laminate plates and conductive end caps on either side thereof. The laminate plates and the end caps have holes near a periphery thereof, and conductive rods are positioned in the holes, and secured to the end caps. The stack, the end caps and the rods are then skewed by a desired angle with respect to a centerline of the rotor. The resulting rotor core may then be mounted to a rotor shaft, and wound, with the windings also being skewed due to skewing of the core. The end caps and rods form a damper cage that aids in reducing harmonics.

### CROSS REFERENCE TO RELATED APPLICATIONS

This application is a Non provisional U.S. Patent Application of U.S. Provisional Application No. 61/676,709, entitled “Rotor and Generator for Reducing Harmonics”, filed Jul. 27, 2012, which is hereby incorporated by reference in its entirety.

### BACKGROUND

The present invention relates generally to electric power generators, and more particularly to rotors used in such equipment.

Electrical power generators are used in a wide variety of applications throughout the industry. For example, such generators may be driven by engines, such as internal combustion engines to generate power needed for specific applications. In a particular type of application, involving welding, plasma cutting and similar operations, an electric motor drives a rotor within a stator of the generator to generate alternating current (AC) power. This power may be rectified into direct current (DC) power, and converted and conditioned in various ways for the final application. Generators of this type may serve specific purposes, such as for welding, plasma cutting and similar operations, or may be more general in purpose, such as for providing emergency or backup power, or for applications requiring power at locations remote from the conventional power grid availability.

Certain generators have been developed for these applications, including generators available commercially from Miller Electric Mfg. of Appleton, Wis., under the commercial designation Bobcat™ and Trailblazer®. Certain of these generators may include rotors with particular geometries adapted to reduce fluctuations in the power generated.

Despite these improvements, further refinement in generator design and manufacture are needed.

### BRIEF DESCRIPTION

The present invention provides a generator and rotor design adapted to respond to such needs. In accordance with certain aspects of the invention, the rotor described employs a mechanism to reduce the currents induced in the rotor from the stator. The mechanism literally “shorts” the currents eliminating the voltage harmonics reflected back into the stator. Eliminating the harmonics improves the sinusoidal waveform creating a “cleaner” power for many applications. In accordance with certain embodiments, then, a rotor for an electrical generator, comprises a laminated core comprising a plurality of laminate plates stacked adjacent to one another, each laminate plate comprising a plurality of holes near a periphery thereof. Conductive end caps are disposed on front and rear sides of the laminated core, each of the end caps comprising a plurality of holes near a periphery thereof. A plurality of conductive rods extend through the holes in the laminate plates and the end caps, and secured to the end caps to form a damper cage. The laminated core and the damper cage are skewed along a length of the rotor.

The invention also provides an electrical generator that comprises a stator and a rotor disposed in the stator. The rotor conforms to the construction outlined above.

In accordance with other aspects, the invention comprises a method for making a rotor for an electrical generator. According to the method, a plurality of laminate plates are stacked, each laminate plate comprising a plurality of holes adjacent to a periphery thereof. Conductive end caps are disposed adjacent to front and rear sides of the stack of laminate plates, each of the end caps comprising a plurality of holes adjacent to a periphery thereof. Conductive rods are disposed in the holes of the laminate plates and the end caps. The stack of laminate plates, the end caps and the rods along a length of thereof are then skewed, and the rods are secured to the end caps.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary application for power conversion circuitry, in the form of a welding system;

FIG. 2 is a circuit diagram for a portion of the power conversion circuitry of FIG. 1, particularly illustrating certain functional circuit components;

FIG. 3 is a diagrammatical representation of an exemplary generator coupled to an engine for use in a system of the type shown in FIG. 2;

FIG. 4 is a perspective view of a rotor of the machine as shown in FIG. 3;

FIG. 5 is an exploded view of certain components of the rotor of FIG. 4;

FIG. 6 is a further exploded view of certain of these components;

FIG. 7 is a top view of the rotor illustrating a skew in the rotor winding and core;

FIG. 8 is an end view of the rotor illustrating the skew;

FIG. 9 is an end view showing only the core and end caps of the rotor;

FIG. 10 is perspective view showing the core and end caps;

FIG. 11 shows a damper cage formed by rods and end caps of the rotor skewed as they will be positioned in the final rotor configuration; and

FIG. 12 is an end view showing the end caps and skew.

### DETAILED DESCRIPTION

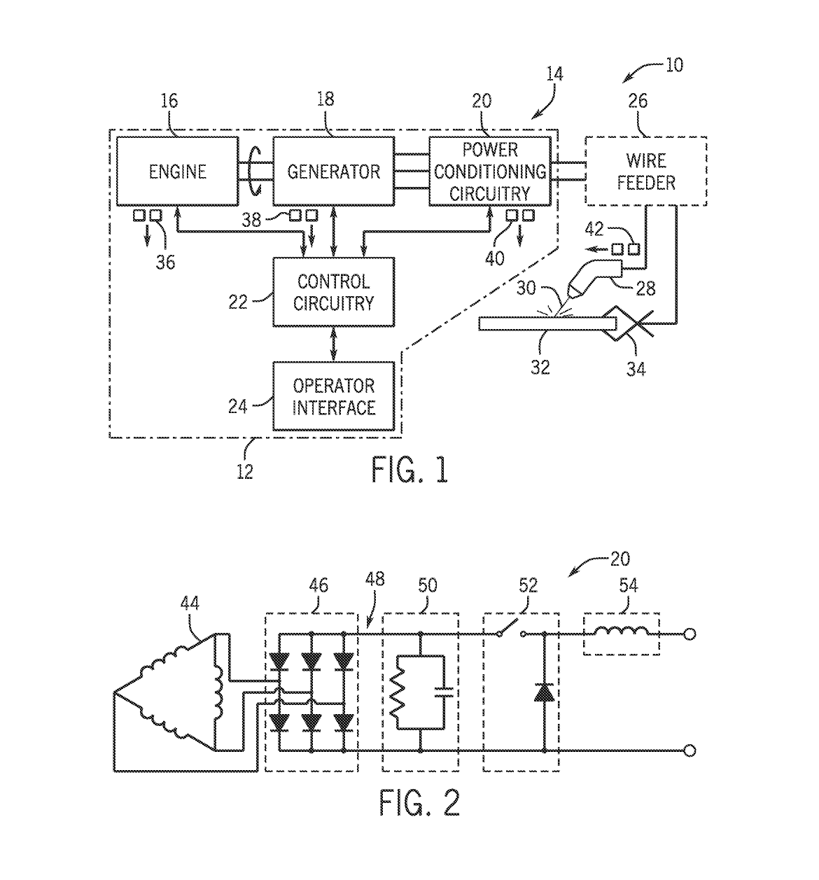

Turning now to the drawings, and referring first to FIG. 1, an exemplary welding system 10 is illustrated that includes a power supply 12 for providing power for welding, plasma cutting and similar applications. The power supply 12 in the illustrated embodiment comprises an engine generator set 14 that itself includes an internal combustion engine 16 and a generator 18. The engine 16 may be of any suitable type, such as gasoline engines or diesel engines, and will generally be of a size appropriate for the power output anticipated for the application. The engine will be particularly sized to drive the generator 18 to produce one or more forms of output power. In the contemplated application, the generator 18 is wound for producing multiple types of output power, such as welding power, as well as auxiliary power for lights, power tools, and so forth, and these may take the form of both AC and DC outputs. Various support components and systems of the engine and generator are not illustrated specifically in FIG. 1, but these will typically include batteries, battery chargers, fuel and exhaust systems, and so forth.

Power conditioning circuitry 20 is coupled to the generator 18 to receive power generated during operation and to convert the power to a form desired for a load or application. In the illustrated embodiment generator 18 produces three-phase power that is applied to the power conditioning circuitry 20. In certain embodiments, however, the generator may produce single phase power. The power conditioning circuitry includes components which receive the incoming power, converted to a DC form, and further filter and convert the power to the desired output form. More will be said about the power conditioning circuitry 20 in the discussion below.

The engine 16, the generator 18 and the power conditioning circuitry 20 are all coupled to control circuitry, illustrated generally by reference numeral 22. In practice, the control circuitry 22 may comprise one or more actual circuits, as well as firmware and software configured to monitor operation of the engine, the generator and the power conditioning circuitry, as well as certain loads in specific applications. Portions of the control circuitry may be centrally located as illustrated, or the circuitry may be divided to control the engine, generator and power conditioning circuitry separately. In most applications, however, such separated control circuits may communicate with one another in some form to coordinate control of these system components. The control circuitry 22 is coupled to an operator interface 24. In most applications, the operator interface will include a surface-mounted control panel that allows a system operator to control aspects of the operation and output, and to monitor or read parameters of the system operation. In a welding application, for example, the operator interface may allow the operator to select various welding processes, current and voltage levels, as well as specific regimes for welding operations. These are communicated to a control circuitry, which itself comprises one or more processors and support memory. Based upon the operator selections, then, the control circuitry will implement particular control regimes stored in the memory via the processors. Such memory may also store temporary parameters during operation, such as for facilitating feedback control.

Also illustrated in FIG. 1 for the welding application is an optional wire feeder 26. As will be appreciated by those skilled in the art, such wire feeders are typically used in gas metal arc welding (GMAW) processes, commonly referred to as metal inert gas (MIG) processes. In such processes a wire electrode is fed from the wire feeder, along with welding power and, where suitable, shielding gas, to a welding torch 28. In other applications, however, the wire feeder may not be required, such as for processes commonly referred to as tungsten inert gas (TIG) and stick welding. In all of these processes, however, at some point and electrode 30 is used to complete a circuit through a workpiece 32 and a work clamp 34. The electrode thus serves to establish and maintain an electric arc with the workpiece that aides in melting the workpiece and some processes the electrode, to complete the desired weld.

To allow for feedback control, the system is commonly equipped with a number of sensors which provide signals to the control circuitry during operation. Certain sensors are illustrated schematically in FIG. 1, including engine sensors 36, generator sensors 38, power conditioning circuitry sensors 40, and application sensors 42. As will be appreciated by those skilled in the art, in practice, a wide variety of such sensors may be employed. For example, engine sensors 36 will typically include speed sensors, temperature sensors, throttle sensors, and so forth. The generator sensors 38 will commonly include voltage and current sensors, as will the power conditioning circuitry sensors 40. The application sensors 42 will also typically include at least one of current and voltage sensing capabilities, to detect the application of power to the load.

FIG. 2 illustrates electrical circuitry that may be included in the power conditioning circuitry 20 illustrated in FIG. 1. As shown in FIG. 2, this circuitry may include the generator windings 44, illustrated here as arranged in a delta configuration, that output three-phase power to a rectifier 46. In the illustrated embodiment the three-phase rectifier is a passive rectifier comprising a series of diodes that provide a DC waveform to a DC bus 48. Power on the DC bus is then applied to filtering and conditioning circuitry 50 which aide in smoothing the waveform, avoiding excessive perturbations to the DC waveform, and so forth. The DC power is ultimately applied to a switch module 52, which in practice comprises a series of switches and associated electronic components, such as diodes. In welding applications, particular control regimes may allow for producing pulsed output, AC output, DC output, and particularly adapted regimes suitable for specific processes. As will be appreciated by those skilled in the art, various switch module designs may be employed, and these may use available components, such as insulated gate bipolar transistors (IGBTs), silicon controlled rectifiers (SCRs), transformers, and so forth. Many of these will be available in packaging that includes both the switches and/or diodes in appropriate configurations.

Finally, an output inductor 54 is typically used for welding applications. As will be appreciated by those skilled in the welding arts, the size and energy storage capacity of the output inductor is selected to suit the output power (voltage and current) of the anticipated application. Although not illustrated, it should also be noted that certain other circuitry may be provided in this arrangement, and power may be drawn and conditioned in other forms.

While only certain features of the exemplary systems have been illustrated and described herein, many modifications and changes will occur to those skilled in the art. For example, in addition to the output terminals illustrated in FIG. 2, power may be drawn from the DC bus for use in other conversion processes. This may allow for DC welding, for example, as well as for the supply of synthetic AC power for various auxiliary applications. The synthetic auxiliary power may be adapted, for example, for single phase power tools, lighting, and so forth. Where provided, such power may be output via separate terminals, or even conventional receptacles similar to those used for power grid distribution.

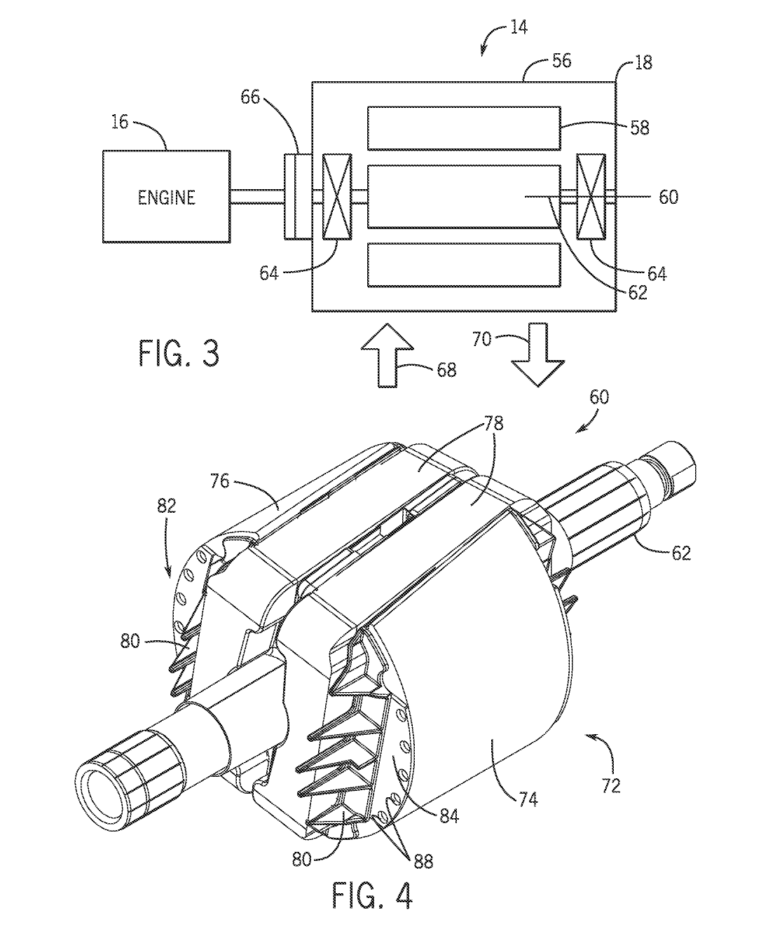

FIG. 3 illustrates certain functional components of the generator for use in a system of the type described above. As mentioned above, the engine 16 is coupled to a generator 18 to produce electrical power used for the welding, plasma cutting or other applications. The generator itself comprises a housing 58 in which a stator 58 is disposed. The stator is wound with stator windings (not shown) to produce the desired output upon rotation of a rotor 60. The rotor comprises a shaft 62 that is supported by a bearing 64. A coupling 66 serves to transmit rotational torch to the shaft of the generator as the engine is powered. Input signals 68 are provided to a generator, such as for excitation of the winding. Power signals 70 are received from the stator as the rotor is turned.

In a presently contemplated embodiment, multiple slots (not separately shown) are included in the rotor, which comprises a variety of windings used to generate the desired power. Specifically, in the illustrated embodiment the generator produces three-phase welding power output, single-phase auxiliary power output, three-phase synthetic AC power output, 24 volt output for powering a wire feeder, and includes a 200 volt excitation coil.

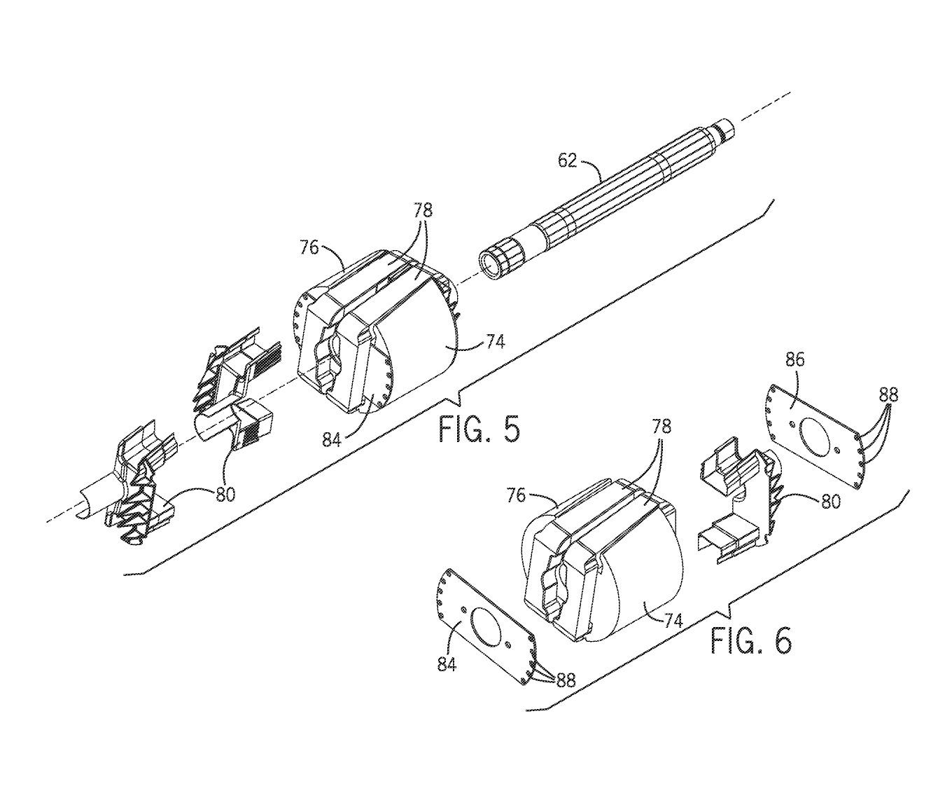

To reduce or remove slot harmonics that could be generated by the alignment of winding slots of the stator with winding slots of the rotor, the rotor is twisted or skewed as illustrated in FIG. 4. Specifically, the rotor comprises a laminated core 72 illustrated as having a first side 74 and second side 76. Windings 78 are disposed between these sides of the laminated core. The windings are separated from the core by non-conductive separators 80. As described more fully below, a damper cage 82 is defined by a front end cap 84 and a rear end cap 86 (see, e.g., FIG. 6) and by rods that connect these conductive end caps to one another in the final assembly (shown and discussed below). The structure of FIG. 4 is illustrated in exploded views in FIGS. 5 and 6. Specifically, in FIG. 5 certain of the separators 80 are exploded away from the rotor core and windings, and the shaft 62 is removed to show the sub-assembly of the core, damper cage and windings. FIG. 6 shows the conductive end cap laminations 84 and 86 removed. As may be seen in FIG. 6, these end caps, made of a non-ferrous, conductive thin plate material forming a lamination, each comprises a central aperture for the shaft and peripheral apertures 88 that accommodate rods that will form, with the end cap laminations, the desired damper cage that aids in removing or reducing slot harmonics.

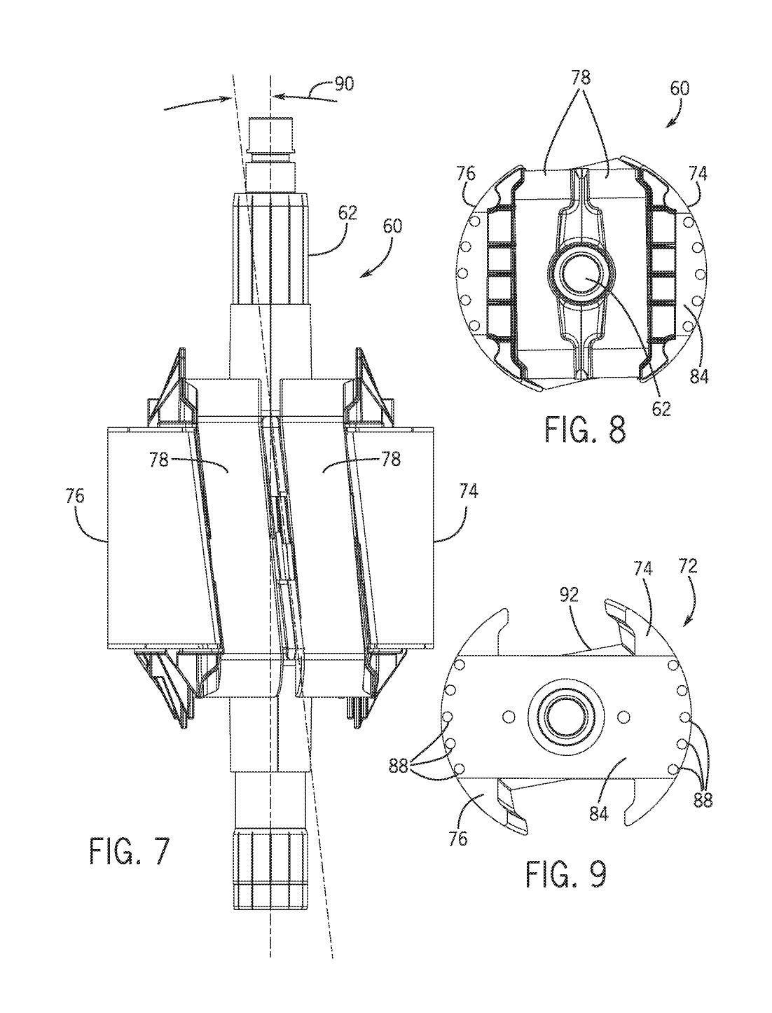

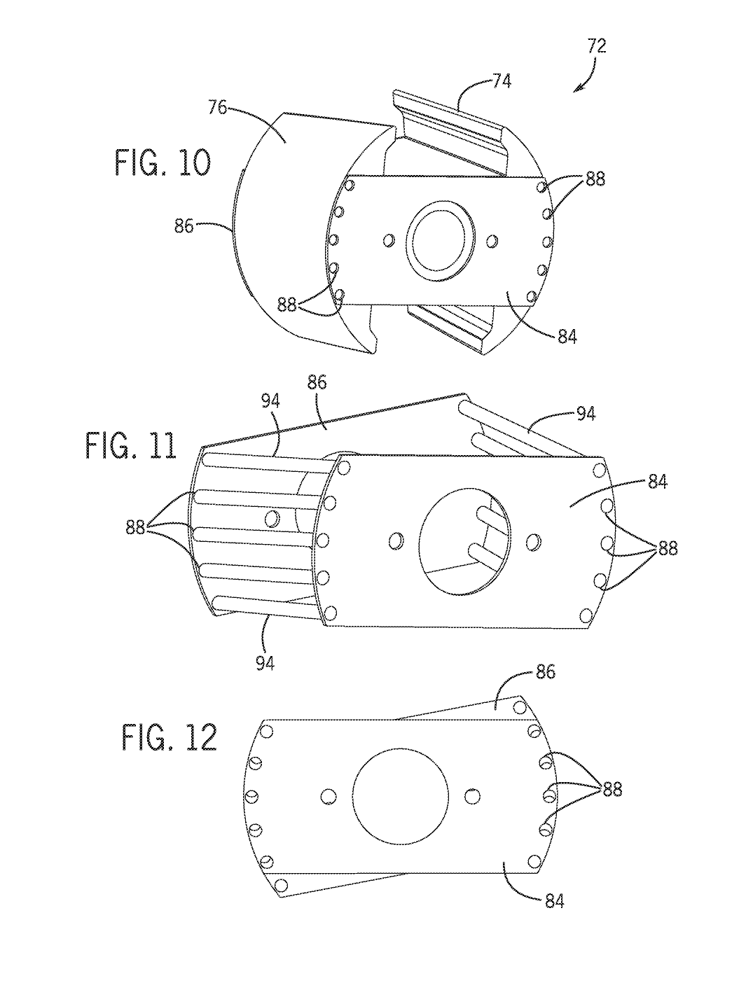

FIGS. 7, 8 and 9 illustrate the skew formed in the rotor windings. In particular, as best shown in FIG. 7, the shaft 90 has a center line which is displaced angularly from an orientation of the windings 78 by an angle 90. This angle is caused by twisting of the rotor core prior to winding. In a presently contemplated embodiment, for example, a skew angle of approximately 10 degrees is employed. The skew is further shown in FIG. 8, which is an end view of the rotor, as well as in FIG. 9 in which the shaft and windings have been removed. As may be seen in FIG. 9, the apertures 88 of the end cap lamination 84 (and similarly of the opposite end cap lamination) are provided with a series of apertures 88 through which rods will be mounted in the core. Although not separately shown, similar apertures are provided in each of the core laminations forming the sides and a bridge section 92. That is, each lamination generally has a rounded H shape with sides 74 and 76 extending around the central bridge section 92, to form recesses for receiving the rotor windings. The skew is further illustrated in the sub-assembly view of FIG. 10.

As shown in FIG. 11, the damper cage 82 is formed by linking the front end cap lamination 84 with the rear end cap lamination 86 by means of a series of rods 94 extending between and receive in the apertures 88. In the presently contemplated embodiment, 10 aluminum bars are positioned in these apertures, and extend through similar apertures in the laminations. The skew between the front end cap lamination and the rear end cap lamination is seen in FIG. 11, as well as in FIG. 12, which is an end-on view.

In a presently contemplated embodiment, the rotor is formed by first producing the sub-components, such as the laminations and front and rear end cap laminations. These may be punched or stamped from a thin plate-like material, and are in a present embodiment are made of steel with a nominal thickness of 0.028 in. The laminations are then stacked in a straight (not skewed) configuration, with a predefined number of laminations disposed between the front and rear end cap aluminum laminations. The aluminum bars are then inserted through the end cap laminations and the core laminations. The structure is then twisted to the desired angle, such as 10 degrees of skew. The end cap laminations are then secured to the ends of the rods, such as by staking, welding, or similar operations. The already-skewed core may then be pressed onto the rotor shaft, and the windings placed on the core to complete the sub-assembly along with the other rotor components as described above.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A rotor for an electrical generator, comprising:
a laminated core comprising a plurality of laminate plates stacked adjacent to one another, each laminate plate comprising a plurality of holes near a periphery thereof;
conductive end caps disposed on front and rear sides of the laminated core, each of the end caps comprising a plurality of holes near a periphery thereof; and
a plurality of conductive rods extending through the holes in the laminate plates and the end caps, and secured to the end caps to form a damper cage;
wherein the laminated core and the damper cage are skewed along a length of the rotor.

2. The rotor of claim 1, wherein the laminated core and the damper cage are skewed at an angle of approximately 10 degrees with respect to a centerline of the rotor.

3. The rotor of claim 1, wherein the laminate plates comprise recesses for receiving rotor windings, and wherein the rotor windings are skewed with the laminated core and the damper cage.

4. The rotor of claim 1, comprising 10 rods disposed in sets of 5 on either side of the damper cage.

5. The rotor of claim 1, wherein the rods comprise aluminum or an aluminum alloy.

6. The rotor of claim 1, wherein the rods are welded to the end caps.

7. An electrical generator comprising:
a stator; and
a rotor disposed rotatably within the stator, the rotor comprising a laminated core comprising a plurality of laminate plates stacked adjacent to one another, each laminate plate comprising a plurality of holes near a periphery thereof, conductive end caps disposed on front and rear sides of the laminated core, each of the end caps comprising a plurality of holes near a periphery thereof, and a plurality of conductive rods extending through the holes in the laminate plates and the end caps, and secured to the end caps to form a damper cage, wherein the laminated core and the damper cage are skewed along a length of the rotor.

8. The generator of claim 7, wherein the rotor comprises a shaft and rotor windings received on the laminated core, the rotor windings being skewed with the laminated core and damper cage.

9. The generator of claim 7, wherein the laminated core and the damper cage are skewed at an angle of approximately 10 degrees with respect to a centerline of the rotor.

10. The generator of claim 7, comprising 10 rods disposed in sets of 5 on either side of the damper cage.

11. The generator of claim 7, wherein the rods comprise aluminum or an aluminum alloy.

12. The generator of claim 7, wherein the rods are welded to the end caps.

13. A method for making a rotor for an electrical generator, comprising:
stacking a plurality of laminate plates, each laminate plate comprising a plurality of holes adjacent to a periphery thereof;
disposing conductive end caps adjacent to front and rear sides of the stack of laminate plates, each of the end caps comprising a plurality of holes adjacent to a periphery thereof;
disposing conductive rods in the holes of the laminate plates and the end caps;
skewing the stack of laminate plates, the end caps and the rods along a length of thereof; and
securing the rods to the end caps.

14. The method of claim 13, wherein the stack of laminate plates, the end caps and the rods are skewed at an angle of approximately 10 degrees with respect to a centerline of the rotor.

15. The method of claim 13, comprising securing the laminate stack, the end caps and the rods as a skewed subassembly to a rotor shaft after skewing.

16. The method of claim 15, comprising disposing rotor windings on the laminate stack after securing mounting to the shaft.

17. The method of claim 15, wherein the laminate stack is pressed onto the shaft.

18. The method of claim 13, comprising 10 rods disposed in sets of 5 on either side of the rotor.

19. The method of claim 13, wherein the rods comprise aluminum or an aluminum alloy.

20. The generator of claim 13, wherein the rods are welded to the end caps.
